(19) United States
(12) Patent Application Publication
(10) Pub. No.: US 2011/0161210 A1
(43) Pub. Date: Jun. 30, 2011

(54) SYSTEM AND METHOD FOR PROVIDING TECHNICAL SUPPORT

(76) Inventor: David Trent Edwards, Chicago, IL (US)

(21) Appl. No.: 12/649,896

(22) Filed: Dec. 30, 2009

(51) Int. Cl. G06Q 99/00; G06Q 10/00

(52) U.S. Cl. 705/30; 705/304

(57) ABSTRACT

A computer-implemented method, computer program product, and computing system for receiving a technical support inquiry from a third party concerning a technical issue associated with a multi-component product including a plurality of technical components. The technical components are produced by a plurality of entities. The technical issue is associated with one or more of the plurality of entities, thus defining one or more identified entities.

### TECHNICAL FIELD

This disclosure relates to technical support systems and, more particularly, to technical support systems that provide technical support for multi-component products.

### BACKGROUND

When products are purchased by a consumer, technical support services are often provided for such products. Unfortunately, as the products become more technical, the skill level of the person staffing the technical support system must also increase. For example, rotary telephones evolved into touchtone telephones, which evolved into cordless telephones, which evolved into cellular telephones.

Further complicating the technical support paradigm is the evolution of multi-component products in which a single manufacturer does not produce the entire product. For example, in a personal digital assistant offered by a nationwide cellular carrier, a first company may produce the physical device, a second company may produce the operating system, a third company may produce the application software, and a fourth company (i.e., the nationwide cellular carrier) may provide the network accessibility. Accordingly, a technical support person employed by the nationwide cellular carrier may be required to provide technical support for a product (e.g., the operating system) that the company that employs them did not produce.

Further complicating the technical support paradigm is the networking of these complex products. Using the product in the previous paragraph as an example, this personal digital assistant can be networked to and interact with your computer, your automobile our your home gateway device. Accordingly, a technical support person employed by the same nationwide cellular carrier may be required to provide technical support for the product in the above example as well as the connectivity of this product with the computer, the automobile and the home gateway.

### SUMMARY OF DISCLOSURE

In a first implementation, a computer-implemented method includes receiving a technical support inquiry from a third party concerning a technical issue associated with a multi-component product including a plurality of technical components. The technical components are produced by a plurality of entities. The technical issue is associated with one or more of the plurality of entities, thus defining one or more identified entities.

One or more of the following features may be included. Technical data may be accessed relating to the technical issue from one or more of the identified entities. The technical support inquiry may be forwarded to one or more of the identified entities.

Associating the technical issue with one or more of the plurality of entities may include associating the technical issue with one or more of the technical components, thus identifying one or more identified technical components and associating one or more of the identified technical components with one or more of the plurality of entities, thus defining one or more identified entities.

A cost may be identified for the technical support inquiry, thus defining an identified cost. The one or more identified entities may include a single identified entity, and the identified cost may be associated with the single identified entity. The one or more identified entities may include a plurality of identified entities, and the identified cost may be apportioned amongst the plurality of identified entities. The technical support inquiry may be chosen from the group consisting of: a telephone-based technical support inquiry; a web-based technical support inquiry; and an email-based technical support inquiry.

In another implementation of this disclosure, a computer program product resides on a computer readable medium and has a plurality of instructions stored on it. When executed by a processor, the instructions cause the processor to perform operations including receiving a technical support inquiry from a third party concerning a technical issue associated with a multi-component product including a plurality of technical components. The technical components are produced by a plurality of entities. The technical issue is associated with one or more of the plurality of entities, thus defining one or more identified entities.

One or more of the following features may be included. Technical data may be accessed relating to the technical issue from one or more of the identified entities. The technical support inquiry may be forwarded to one or more of the identified entities.

Associating the technical issue with one or more of the plurality of entities may include associating the technical issue with one or more of the technical components, thus identifying one or more identified technical components and associating one or more of the identified technical components with one or more of the plurality of entities, thus defining one or more identified entities.

A cost may be identified for the technical support inquiry, thus defining an identified cost. The one or more identified entities may include a single identified entity, and the identified cost may be associated with the single identified entity. The one or more identified entities may include a plurality of identified entities, and the identified cost may be apportioned amongst the plurality of identified entities. The technical support inquiry may be chosen from the group consisting of: a telephone-based technical support inquiry; a web-based technical support inquiry; and an email-based technical support inquiry.

In another implementation, a computing system includes at least one processor and at least one memory architecture coupled with the at least one processor. A first software module is executed on the at least one processor and the at least one memory architecture. The first software module is configured to receive a technical support inquiry from a third party concerning a technical issue associated with a multi-component product including a plurality of technical components. The technical components are produced by a plurality of entities. A second software module is executed on the at least one processor and the at least one memory architecture. The second software module is configured to associate the technical issue with one or more of the plurality of entities, thus defining one or more identified entities.

One or more of the following features may be included. Technical data may be accessed relating to the technical issue from one or more of the identified entities. The technical support inquiry may be forwarded to one or more of the identified entities.

Associating the technical issue with one or more of the plurality of entities may include associating the technical issue with one or more of the technical components, thus identifying one or more identified technical components and associating one or more of the identified technical components with one or more of the plurality of entities, thus defining one or more identified entities.

A cost may be identified for the technical support inquiry, thus defining an identified cost. The one or more identified entities may include a single identified entity, and the identified cost may be associated with the single identified entity. The one or more identified entities may include a plurality of identified entities, and the identified cost may be apportioned amongst the plurality of identified entities. The technical support inquiry may be chosen from the group consisting of: a telephone-based technical support inquiry; a web-based technical support inquiry; and an email-based technical support inquiry.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a multi-party support process executed in whole or in part by a computer coupled to a distributed computing network; and

FIG. 2 is a flowchart of the multi-party support process of FIG. 1.

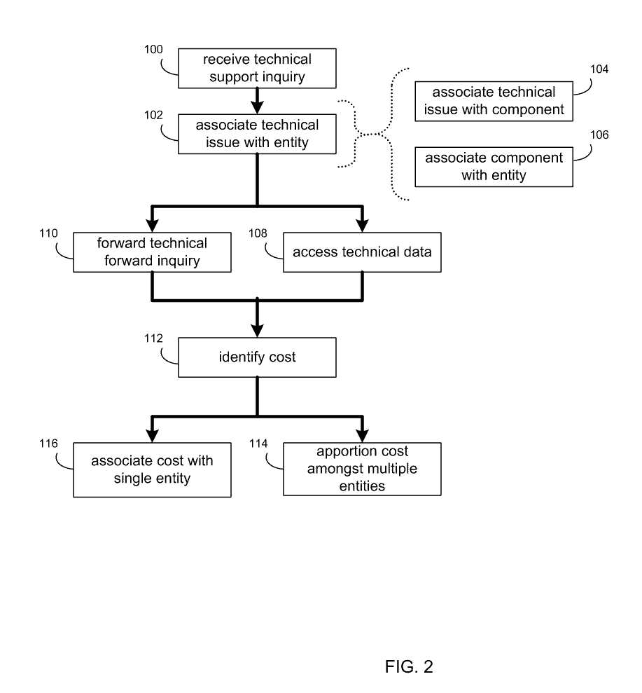

### DETAILED DESCRIPTION OF THE PREFERRED EMBODIMENTS

### System Overview

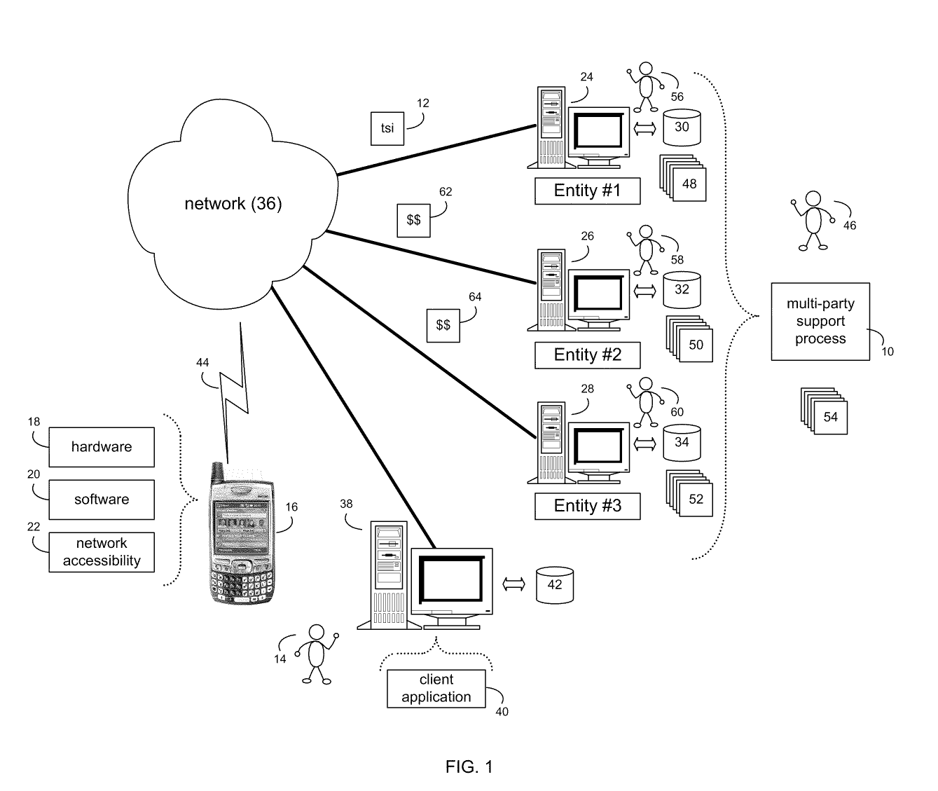

Referring to FIGS. 1 & 2, there is shown multi-party support process 10. As will be discussed below in greater detail, direction generation process 10 may receive 100 a technical support inquiry 12 from a third party (e.g., user 14) concerning a technical issue (e.g., a non-functioning speakerphone) associated with a multi-component product (e.g., smart phone 16) including a plurality of technical components (e.g., hardware 18, software 20, and network accessibility 22). These technical components (e.g., hardware 18, software 20, and network accessibility 22) may be produced by a plurality of entities. For example, hardware 18 may be produced by Palm™ Inc. of Sunnyvale, Calif.; software 20 may be produced by The Microsoft™ Corporation of Redmond, Wash.; and network accessibility 22 may be provided by T-Mobile™ USA of Bellevue, Wash. The technical issue (e.g., non-functioning speakerphone) may be associated 102 with one or more of the plurality of entities (e.g., Palm™ Inc.), thus defining one or more identified entities.

While the multi-component product is described above as being a smart phone 16, this is for illustrative purposes only and is not intended to be a limitation of this disclosure, as other configurations are possible and are considered to be within the scope of this disclosure. For example, the above-described multi-component product may alternatively be e.g., an MP3 player, a computer system, or a stereo system.

Multi-party support process 10 may be a solitary process executed (in whole or in part) on a single computer or a distributed process that is executed on a plurality of computers. For example, multi-party support process 10 may be a solitary computing process executed on a single computer (e.g., computer 24) operated and maintained by a single entity (e.g., T-Mobile™ USA of Bellevue, Wash.). Alternatively, multi-party support process 10 may be a distributed computing process executed (in whole or in part) across a plurality of computers (e.g., computer 24 operated and maintained by e.g., T-Mobile™ USA of Bellevue, Wash.; computer 26 operated and maintained by e.g., The Microsoft™ Corporation of Redmond, Wash. (Entity #2); computer 28 operated and maintained by e.g., Palm™ Inc. of Sunnyvale, Calif. (Entity #3). Accordingly and for the following discussion, the multi-party support process will be described generally as multi-party support process 10, with the understanding that multi-party support process 10 may be distributed across multiple computers/locations.

Examples of computer 24, 26, 28 may include but are not limited to a laptop computer, a notebook computer, a desktop computer, a single server computer, a plurality of server computers, and a computing cloud. The instruction sets and subroutines of multi-party support process 10 may be executed by one or more processors (not shown) and one or more memory architectures (not shown) incorporated into computer 24, computer 26 and/or computer 28. Computers 24, 26, 28 may each include a storage device (e.g., storage devices 30, 32, 34, respectively) configured to store the above-described instruction sets and subroutines of multi-party support process 10. Examples of storage devices 30, 32, 34 may include but are not limited to a hard disk drive, a tape drive, an optical drive, a RAID array, a random access memory (RAM), a read-only memory (ROM), a flash memory system, and a cloud storage system.

One or more of computers 24, 26, 28 may be coupled to network 36 (e.g., the Internet, an intranet, a local area network, a wide area network, and/or an extranet). One or more of computers 24, 26, 28 may execute a network operating system (e.g., Microsoft Windows Server™ or Redhat Linux™) and a web server application (e.g., Microsoft IIS™, or Apache Webserver™) to effectuate web-based access to multi-party support process 10 via network 36. For example, user 14 may access multi-party support process 10 via client application 40 (e.g., a web browser such as Microsoft Internet Explorer™) executed on user computer 38.

The instruction sets and subroutines of client application 40 may be executed by one or more processors (not shown) and one or more memory architectures (not shown) incorporated into user computer 38. User computer 38 may include a storage device (e.g., storage devices 42) configured to store the above-described instruction sets and subroutines of client application 40. Examples of storage device 42 may include but are not limited to a hard disk drive, a tape drive, an optical drive, a RAID array, a random access memory (RAM), a read-only memory (ROM), and a flash memory system.

Alternatively, user 14 may access multi-party support process 10 via telephonic connection 44 that couples smart phone 16 with multi-party support process 10 via e.g., network 36 or a POTS (i.e., Plain Old Telephone Service).

While user computer 38 is shown hardwired to network 36, this is for illustrative purposes only and is not intended to be a limitation of this disclosure, as other configurations are possible and are considered to be within the scope of this disclosure. For example, user computer 38 may be wirelessly coupled to network 36 via e.g., a wireless communication channel (not shown) established between user computer 38 and a wireless access point (not shown), which may be directly coupled to network 36.

The above-described wireless access point (not shown) may be, for example, an IEEE 802.11a, 802.11b, 802.11g, Wi-Fi, cellular, and/or Bluetooth device that is capable of establishing a wireless communication channel between user computer 38 and the above-described wireless access point (not shown).

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Multi-Part Support Process:

As discussed above, multi-party support process 10 may receive 100 a technical support inquiry 12 from a third party (e.g., user 14) concerning a technical issue (e.g., non-functioning speakerphone) associated with a multi-component product (e.g., smart phone 16) including a plurality of technical components (e.g., hardware 18, software 20, and network accessibility 22). These technical components (e.g., hardware 18, software 20, and network accessibility 22) may be produced by a plurality of entities (e.g., Palm™ Inc. of Sunnyvale, Calif., The Microsoft™ Corporation of Redmond, Wash., and T-Mobile™ USA of Bellevue, Wash. The technical issue (e.g., non-functioning speakerphone) may be associated with one or more of the plurality of entities (e.g., Palm™ Inc.), thus defining one or more identified entities. While all of the above example companies are US-based companies, this is for illustrative companies only and is not intended to be a limitation of the scope of this disclosure. For example, Nokia of Espoo, Finland may be the manufacturer of hardware 18.

Specifically, assume for illustrative purposes that user 14 is attempting to use smart phone 16 to take a photograph. However, whenever they attempt to take a picture, nothing happens (i.e., no sound, no flash, no picture). Assume for illustrative purposes (and as discussed above) that smart phone 16 is a multi-component product that includes a plurality of technical components (e.g., hardware 18, software 20, and network accessibility 22) that are produced by a plurality of entities. For example, hardware 18 (e.g., the physical smart phone) may be produced by Palm™ Inc. of Sunnyvale, Calif.; software 20 (e.g., the operating system and application software) may be produced by The Microsoft™ Corporation of Redmond, Wash.; and network accessibility (e.g., software that allows access to a cellular network) may be provided by T-Mobile™ USA of Bellevue, Wash.

Accordingly and in response to the malfunction concerning the camera function of smart phone 16, user 14 may contact a technical support service that is available for smart phone 16 and initiate technical support inquiry 12. Examples of the types of technical support service contacted by user 14 may include a technical support service operated and maintained by T-Mobile™ USA of Bellevue, Wash. (i.e., the entity from which user 14 purchased smart phone 16). Alternatively, the technical support service may be operated and maintained by Palm™ Inc. of Sunnyvale, Calif. (i.e., the entity that produced the physical smart phone), or The Microsoft™ Corporation of Redmond, Wash. (e.g., the entity that produced the operating system and application software). Alternatively still, the technical support service may be operated and maintained by a third party that entered into a contract with one or more of T-Mobile™ USA of Bellevue, Wash., Palm™ Inc. of Sunnyvale, Calif., and The Microsoft™ Corporation of Redmond, Wash.

When initiating technical support inquiry 12, technical support inquiry 12 may be made in various ways. For example, technical support inquiry 12 may be a telephone-based technical support inquiry in which user 14 contacts the above-described technical support service by dialing a telephone number and being routed (e.g., through a POTS, or a VoIP network) to multi-party support process 10. Further, if there is a walk-in technical support center, an in-person-based technical support inquiry may be initiated by user 14 via multi-party support service 10. Alternatively, user 14 may initiate a web-based technical support inquiry (e.g., a text-based chat session, a voice-based chat session, an augmented reality technical support inquiry, a message-board-based technical support inquiry, or an audio/video conference session) via e.g., network 36 that accesses multi-party support service 10. Further still, user 14 may initiate an email-based technical support inquiry by sending an email e.g., via network 36) to multi-party support service 10.

Upon receiving 100 technical support inquiry 12 (which may be email-based, telephone-based, or web-based) from user 14 concerning the technical issue (e.g., malfunctioning camera) for smart phone 16 (i.e., a multi-component product that includes hardware 18, software 20 and network accessibility 22), multi-party support process 10 may analyze the technical issue defined within technical support inquiry 12 and associate 102 the technical issue defined by user 14 with one or more of the plurality of entities (e.g., T-Mobile™ USA of Bellevue, Wash., Palm™ Inc. of Sunnyvale, Calif., and The Microsoft™ Corporation of Redmond, Wash.) that produced the various technical components (e.g., hardware 18, software 20 and network accessibility 22) included within smart phone 16, thus defining one or more identified entities.

When receiving 100 technical support inquiry 12, the manner in which multi-part support process 10 initially processes technical support inquiry 12 may vary depending on the specific type of technical support inquiry. For example, web-based technical support inquiries may be assigned to the next available technical support technician. Email-based technical support inquiries may be routed to a generic inbox accessed by the technical support technicians. Alternatively, an email-based technical support inquiry may be preprocessed to look for the occurrence of certain words (e.g., camera, display, screen, and coverage) so that the email-based technical support inquiry may be routed to a non-generic inbox that is associated with a specific technical issue (e.g., problems with the camera). For telephone-based technical support inquiries, an automated phone system (not shown) may ask specific questions of user 14 and ask that responses be entered via the keypad of e.g., smart phone 16, thus allowing the automated phone system (not shown) to properly route the call. Alternatively, a telephone attendant may ask e.g., user 14 specific questions that allow them to place technical support inquiry 12 into the appropriate queue.

When associating 102 the technical issue defined by user 14 within technical support inquiry 12 with one or more of the plurality of entities (e.g., T-Mobile™ USA, Palm™ Inc., and The Microsoft™ Corporation) that produced the various technical components (e.g., hardware 18, software 20 and network accessibility 22) included within smart phone 16, various procedures may be utilized by multi-party support process 10.

For example, multi-party support process 10 may first associate 104 the technical issue defined within technical support inquiry 12 with one or more of the technical components (e.g., hardware 18, software 20 and network accessibility 22) included within smart phone 16, thus identifying one or more identified technical components. Continuing with the above-stated example, upon receiving technical support inquiry 12, inquiry may be made to assist in associating 104 the technical issue with one or more of the technical components (e.g., hardware 18, software 20 and network accessibility 22) included within smart phone 16. This inquiry may be made in a manual fashion, in which e.g., technical support technician 46 asks a series of questions based upon an inquiry script (not shown) provided by multi-party support process 10. Alternatively, the script may be automated and the series of questions may be directly asked by multi-party support process 10 by e.g., synthesizing speech from the questions and asking the verbal questions of user 14 during a telephone-based support session. Alternatively, text-based questions may be asked of user 14 within a chat-based support session.

Continuing with the above-stated example, as this question concerns a malfunctioning camera, assume that the inquiry made by multi-party support system 10 of user 14 determines that the defined technical issue does not concern network accessibility 22 but concerns both hardware 18 and software 20. Upon making this association 104, multi-party support process 10 may associate 106 the identified technical components (e.g., hardware 18 and software 20) with one or more of the plurality of entities (e.g., T-Mobile™ USA, Palm™ Inc., and The Microsoft™ Corporation), thus defining one or more identified entities (e.g., Palm™ Inc. of Sunnyvale, Calif., the entity that produced hardware 18; and The Microsoft™ Corporation of Redmond, Wash., the entity that produced software 20). However, T-Mobile™ USA of Bellevue, Wash., the entity that provides network accessibility 22 may not be defined as an identified entity, as network accessibility 22 was not deemed (by multi-party support process 10) to be the source of the technical issue defined within technical service inquiry 12.

When associating 102 the technical issue defined within technical service inquiry 12 with one or more of the plurality of entities (in this particular example, Palm™ Inc. of Sunnyvale, Calif. and The Microsoft™ Corporation of Redmond, Wash.), multi-part support process 10 may access 108 technical data relating to the technical issue (defined within technical service inquiry 12) from one or more of the identified entities.

As discussed above, computer 24 may be operated and maintained by e.g., T-Mobile™ USA of Bellevue, Wash. (Entity #1); computer 26 may be operated and maintained by e.g., The Microsoft™ Corporation of Redmond, Wash. (Entity #2); and computer 28 may be operated and maintained by e.g., Palm™ Inc. of Sunnyvale, Calif. (Entity #3). For example, each of computers 24, 26, 28 may maintain a database concerning technical data for the specific component provided by the entity maintaining the computer. Specifically, computer 24 may include database 48 of technical data (stored on e.g., storage device 30) that is associated with network accessibility 22 (i.e., the technical component of smart phone 16 produced by T-Mobile™ USA of Bellevue, Wash. (Entity #1). Further, computer 26 may include database 50 of technical data (stored on e.g., storage device 32 that is associated with software 20 (i.e., the technical component of smart phone 16 produced by The Microsoft™ Corporation of Redmond, Wash. (Entity #2). Additionally, computer 28 may include database 52 of technical data (stored on e.g., storage device 34 that is associated with hardware 18 (i.e., the technical component of smart phone 16 produced by Palm™ Inc. of Sunnyvale, Calif. (Entity #3).

Alternatively still, a consolidated database (e.g., master database 54 may be maintained that is a consolidation of the technical data included within e.g., databases 48, 50, 52. Accordingly, databases 48, 50, 52 and master database 54 may be configured so that any changes to databases 48, 50, 52 may be reconciled onto master database 54, Conversely, any changes made to master database 54 may be reconciled onto the appropriate database (chosen from databases 48, 50, 52).

Once the appropriate technical information defined within databases 48, 50, 52 and/or master database 54 is accessed 108, the accessed technical data may be utilized by technical support technician 46 to resolve the problem defined within technical support inquiry 12 (i.e., a malfunctioning camera).

Additionally/alternatively, multi-part support process 10 may be configured to forward 110 technical support inquiry 12 to one or more of the identified entities. For example, each entity (e.g., T-Mobile™ USA, Palm™ Inc., and The Microsoft™ Corporation) that provides a technical component (e.g., hardware 18, software 20 and network accessibility 22) included within smart phone 16 may employ a specialized technical service technician that is skilled in troubleshooting technical issues relating to the technical component provided by their employer. For example, T-Mobile™ USA may employ technical service technician 56 that is skilled in troubleshooting technical issues related to network accessibility 22 (i.e., the technical component provided by T-Mobile™ USA). Additionally, The Microsoft™ Corporation may employ technical service technician 58 that is skilled in troubleshooting technical issues related to software 20 (i.e., the technical component provided by The Microsoft™ Corporation). Further, Palm™ Inc. may employ technical service technician 60 that is skilled in troubleshooting technical issues related to hardware 18 (i.e., the technical component provided by Palm™ Inc.). Accordingly and in this particular example, multi-party support process 10 may forward 110 technical support inquiry 12 to technical support technician 58 and/or technical support technician 60 (i.e., the technical support technicians employed by the two identified entities, namely The Microsoft™ Corporation and Palm™ Inc., respectively.

Multi-party support process 10 may be configured to identify 112 a cost associated with the processing of each technical support inquiry (e.g., technical support inquiry 12), thus defining an identified cost. For example, a typical call to a technical support service may cost anywhere between $5-$20 per minute (depending upon the complexity of the call and the queue that the call is placed into). Accordingly these costs may add up quickly and the various entities associated with a device may only wish to be charged for a call if their portion of the device is at least partially at fault.

When identifying 122 a cost, various methods may be employed. For example, a flat rate may be applied (e.g., the cost associated with processing each technical support inquiry is set at $50.00). Alternatively, a per minute rate may be applied (e.g., $1.00 per minute). Alternatively still, different rates may be applied depending upon the level of technician needed to resolve the problem. For example, a low-level technician may charge $0.50 per minute; a mid-level technician may charge $1.00 per minute; and a high-level technician may charge $2.00 per minute.

This identified cost associated with processing e.g., technical service inquiry 12 may then be borne by one or more of the identified entities. Continuing with the above-stated example in which the identified entities include The Microsoft™ Corporation and Palm™ Inc., respectively. Further, assume for illustrative purposes that, upon further inquiry by multi-party support process 10 that it is determined that there is a fault in the operating system (i.e., software 20 produced by The Microsoft™ Corporation) that is causing hardware 18 (i.e., produced by Palm™ Inc.) to lockup. However, assume that the problem with the operating system is a known problem that is well-documented and easily designed around. Accordingly, while the initial problem was due to a flaw in software 20 produced by The Microsoft™ Corporation, this is a known problem that Palm™ Inc. could have easily designed around.

Accordingly, multi-party support process 10 may be configured to apportion 114 the identified cost amongst The Microsoft™ Corporation and Palm™ Inc. Assuming that multi-user support process 10 determines that The Microsoft™ Corporation is 40% at fault, Palm™ Inc. is 60% at fault, and the cost of processing technical support inquiry 12 as $50.00, multi-party support process 10 may apportion $30.00 of the $50.00 identified cost to Palm™ Inc. and may apportion $20.00 of the $50.00 identified cost to The Microsoft™ Corporation. These apportioned costs (e.g., costs 62, 64) may then be billed to and payable by the appropriate identified entities. In the event that a single entity is identified (e.g., multi-party support process 10 determines that The Microsoft™ Corporation is 100% at fault), multi-part support process 10 may associate 116 the identified cost with the single identified entity (i.e., The Microsoft™ Corporation). These costs may then be billed to and payable by the appropriate identified entities (i.e., The Microsoft™ Corporation).

The technical support service described above may be a technical support website that may provide technical support information and may allow user 14 to download various software patches/upgrades to effectuate resolution of any technical problems that user 14 may be having with their device. Accordingly and in this particular embodiment, multi-party support process 10 may be configured to identify 112, apportion 114, and/or associate 116 costs based upon the data (e.g., technical support bulletins and/or software patches/upgrades) retrieved from the technical support website.

A number of implementations have been described. Nevertheless, it will be understood that various modifications may be made. Accordingly, other implementations are within the scope of the following claims.

What is claimed is:

1. A computer-implemented method comprising:
receiving a technical support inquiry from a third party concerning a technical issue associated with a multi-component product including a plurality of technical components, wherein the technical components are produced by a plurality of entities; and
associating the technical issue with one or more of the plurality of entities, thus defining one or more identified entities.

2. The computer-implemented method of claim 1 further comprising:
accessing technical data relating to the technical issue from one or more of the identified entities.

3. The computer-implemented method of claim 1 further comprising:
forwarding the technical support inquiry to one or more of the identified entities.

4. The computer-implemented method of claim 1 wherein associating the technical issue with one or more of the plurality of entities includes:
associating the technical issue with one or more of the technical components, thus identifying one or more identified technical components; and
associating one or more of the identified technical components with one or more of the plurality of entities, thus defining one or more identified entities.

5. The computer-implemented method of claim 1 further comprising:
identifying a cost for the technical support inquiry, thus defining an identified cost.

6. The computer-implemented method of claim 5 wherein the one or more identified entities includes a single identified entity, the computer-implemented method further comprising:
associating the identified cost with the single identified entity.

7. The computer-implemented method of claim 5 wherein the one or more identified entities includes a plurality of identified entities, the computer-implemented method further comprising:
apportioning the identified cost amongst the plurality of identified entities.

8. The computer-implemented method of claim 1 wherein the technical support inquiry is chosen from the group consisting of:
a telephone-based technical support inquiry;
a web-based technical support inquiry; and
an email-based technical support inquiry.

9. A computer program product residing on a computer readable medium having a plurality of instructions stored thereon that, when executed by a processor, cause the processor to perform operations comprising:
receiving a technical support inquiry from a third party concerning a technical issue associated with a multi-component product including a plurality of technical components, wherein the technical components are produced by a plurality of entities; and
associating the technical issue with one or more of the plurality of entities, thus defining one or more identified entities.

10. The computer program product of claim 9 further comprising instructions for:
accessing technical data relating to the technical issue from one or more of the identified entities.

11. The computer program product of claim 9 further comprising instructions for:
forwarding the technical support inquiry to one or more of the identified entities.

12. The computer program product of claim 9 wherein the instructions for associating the technical issue with one or more of the plurality of entities include instructions for:
associating the technical issue with one or more of the technical components, thus identifying one or more identified technical components; and
associating one or more of the identified technical components with one or more of the plurality of entities, thus defining one or more identified entities.

13. The computer program product of claim 9 further comprising instructions for:
identifying a cost for the technical support inquiry, thus defining an identified cost.

14. The computer program product of claim 13 wherein the one or more identified entities includes a single identified entity, the computer program product further comprising instructions for:
associating the identified cost with the single identified entity.

15. The computer program product of claim 13 wherein the one or more identified entities includes a plurality of identified entities, the computer program product further comprising instructions for:
apportioning the identified cost amongst the plurality of identified entities.

16. The computer program product of claim 9 wherein the technical support inquiry is chosen from the group consisting of:
a telephone-based technical support inquiry;
a web-based technical support inquiry; and
an email-based technical support inquiry.

17. A computing system comprising:
at least one processor;
at least one memory architecture coupled with the at least one processor;
a first software module executed on the at least one processor and the at least one memory architecture, wherein the first software module is configured to receive a technical support inquiry from a third party concerning a technical issue associated with a multi-component product including a plurality of technical components, wherein the technical components are produced by a plurality of entities; and
a second software module executed on the at least one processor and the at least one memory architecture, wherein the second software module is configured to associate the technical issue with one or more of the plurality of entities, thus defining one or more identified entities.

18. The computing system of claim 17 further comprising:
a third software module executed on the at least one processor and the at least one memory architecture, wherein the third software module is configured to access technical data relating to the technical issue from one or more of the identified entities.

19. The computing system of claim 17 further comprising:
a fourth software module executed on the at least one processor and the at least one memory architecture, wherein the fourth software module is configured to forward the technical support inquiry to one or more of the identified entities.

20. The computing system of claim 17 wherein the second software module is further configured to:
associate the technical issue with one or more of the technical components, thus identifying one or more identified technical components; and
associate one or more of the identified technical components with one or more of the plurality of entities, thus defining one or more identified entities.

21. The computing system of claim 17 further comprising:
a fifth software module executed on the at least one processor and the at least one memory architecture, wherein the fifth software module is configured to:
identify a cost for the technical support inquiry, thus defining an identified cost;
associate the identified cost with a single identified entity if the one or more identified entities includes the single identified entity; and
apportion the identified cost amongst a plurality of identified entities if the one or more identified entities includes a plurality of identified entities.

22. The computing system of claim 17 wherein the technical support inquiry is chosen from the group consisting of:
a telephone-based technical support inquiry;
a web-based technical support inquiry; and
an email-based technical support inquiry.
